(19) United States
(12) Patent Application Publication
(10) Pub. No.: US 2005/0282982 A1
(43) Pub. Date: Dec. 22, 2005

(54) Amido complexes of vanadium for olefin polymerization

(76) Inventors: Michael Arndt-Rosenau, Dormagen (DE); Jorg Sundermeyer, Marburg (DE); Martin Lemke, Lahntal (DE)

Correspondence Address: LANXESS CORPORATION, 111 RIDC PARK WEST DRIVE, PITTSBURGH, PA, 15275-1112, US

(21) Appl. No.: 11/152,718

(22) Filed: Jun. 14, 2005

(30) Foreign Application Priority Data
Jun. 17, 2004 (DE) 1020040292736

(51) Int. Cl. C07F 9/00; C08F 4/06

(52) U.S. Cl. 526/192; 556/42

(57) ABSTRACT

The present invention relates to compounds containing vanadium in the oxidation state +III or +IV and one or more amido groups, a process for preparing these compounds, the use of the compounds of the invention for preparing a catalyst composition, a process for preparing the catalyst composition and also a process for preparing homopolymers and/or copolymers using the catalyst composition.

The present invention relates to compounds containing vanadium in the oxidation state +III or +IV and one or more amido groups, a process for preparing these compounds, the use of the compounds of the invention for preparing a catalyst composition, a process for preparing the catalyst composition and also a process for preparing homopolymers and/or copolymers using the catalyst composition.

There is a great need for compounds which display improved polymerization activities in the presence of customary cocatalysts.

In J. Chem. Soc., Dalton Trans. 2000, 4497-4498, and Inorg. Chem. 41 (2002), 4217-4226, Lorber et al. have described the synthesis of aryl-imido-vanadium(IV) compounds which may also bear amido groups as further ligands. These compounds have the disadvantage that they are generally in dimeric or polymeric form if the coordination sphere is not saturated by further ligands.

Some results for the polymerization of ethene using these compounds are disclosed in J. Chem. Soc., Dalton Trans. 2000, 4497-4498. It is in this case found that methylaluminoxane is a better cocatalyst than simple aluminium alkyls.

In Organometallics 19 (2000), 1963-1966, Lorber et al. describe a diamido-dichlorovanadium(IV) compound and its use as catalyst for the polymerization of ethene. In this case too, activation is effected by means of methylaluminoxane, but the polymerization activity is described as low.

In U.S. Pat. No. 3,711,455, Cucinella et al. describe polymerization catalysts based on:
(I) a vanadium compound of the type V(NR₂)₄ or V(NR₂)₂X₂, where R is an alkyl, aryl or cycloalkyl group and X is a halogen atom such as Cl, Br or I; and
(II) is an aluminium alkyl compound of the type AlRₓX₃₋ₓ, where R is an alkyl, aryl or cycloalkyl group and X is a halogen atom such as Cl, Br or I; and x is in the range from 1 to 2.

Cucinella et al. teach that the use of such a catalyst allows the copolymerization of monoolefins and diolefins. However, the activities of these catalysts are not as high as that of the catalyst composition of the invention.

In EP 950 670, H. A. Zahalky describes the use of a catalyst system based on:
(I) a vanadium compound of the type VR^{a}R^{b}R^{c}R^{d} or VR^{a}R^{b}R^{c}, where R^{a},R^{b},R^{c} and R^{d} are identical or different and are each selected from among halogen or —(NR^{e}R^{f}); R^{e} and R^{f} are alkyl, alkenyl, aryl, cycloalkyl or silicon-containing hydrocarbon groups; at least one of the groups R^{a}-R^{c} is such an amido group;
(II) an organoaluminium compound as cocatalyst; and
(III) an activator based on a compound of the type MR^{g}ₙ, where M can be a metal of group 2 or 12 of the Periodic Table and R^{g} is a C₁-C₁₂-alkyl group; n corresponds to the valency of M.

The use of these catalyst systems without the component (III) for olefin polymerization is described by N. Desmangles et al. in J. Organomet. Chem. 562 (1998), 53-60.

In Organometallics 19 (2000), 1963-1966, Lorber et al. describe the synthesis of a dichloro complex of vanadium(IV) having a chelating diamide as ligand and report an activity for the polymerization of ethene which is low in conjunction with MAO.

In J. Chem. Soc. Dalton Trans. 1997, 4795-4805, C. P. Gerlach and J. Arnold report V(III) complexes which have two amido ligands and one chloro ligand and can be converted into the corresponding alkyl or aryl species by reaction with lithium or magnesium alkyl or aryl compounds with replacement of the chloro ligand. The resulting complexes are stabilized by uncharged ligands such as tetrahydrofuran. Use of such compounds as catalysts for olefin polymerization is not described.

It is therefore an object of the present invention to provide a compound which in combination with other cocatalysts gives a higher polymerization activity and thus better yields.

This object is achieved by compounds of the formula (I)
QL¹_{y}L²_{z}V(NR¹R²)ₓ (I)
where
V is vanadium in the oxidation state +III or +IV,
Q is a ligand selected from the group of monodentate ligands, with halides and amido groups of the type (NR¹R²)⁻ being excluded as monodentate ligand for Q,
L¹ and L² are identical or different and are selected independently from the group consisting of monodentate ligands, where
y is 0 or 1,
z is 0 or 1 and the sum of x, y and z is 2 when the oxidation state of vanadium is +III and the sum of x, y and z is 3 when the oxidation stage of vanadium is +IV,
N is nitrogen,
R¹ and R² are identical or different and are selected independently from the group consisting of alkyl, aryl, heteroaryl, alkenyl groups and silicon-containing hydrocarbon radicals, where
x can be an integer from 1 to 3 when the oxidation state of vanadium is +IV and can be 1 or 2 when the oxidation state of vanadium is +III.
1. Advantageous compounds include compounds according to the invention having the formula (II) 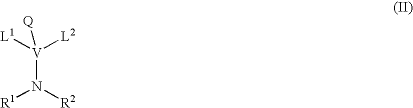
   where
   V is vanadium in the oxidation state +IV,
   Q is a ligand selected from the group of monodentate ligands, with halides and amido groups of the type (NR¹R²)⁻ being excluded as monodentate ligand for Q,
   L¹ and L² are identical or different and are selected independently from the group consisting of (NR¹R²)⁻, RO⁻, RS⁻, RCOO⁻ and phosphoraniminato groups, where R is selected from the group consisting of alkyl, alkenyl, cycloalkyl and aryl groups,
   N is nitrogen and
   R¹ and R² are identical or different and are selected independently from the group consisting of alkyl, aryl, heteroaryl, alkenyl groups and silicon-containing hydrocarbon radicals.

Compounds according to the invention in which L¹ or L² is a (NR¹R²)⁻ group are advantageous. Compounds according to the invention in which L¹ and L² are identical or different (NR¹R²)⁻ groups are advantageous.

Advantageous compounds include compounds according to the invention having the formula (III) 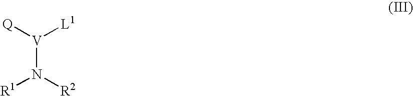
where
V is vanadium in the oxidation state +III,
Q is a ligand selected from the group of monodentate ligands, with halides and (NR¹R²)⁻ groups being excluded as monodentate ligand for Q,
L¹ is selected from the group consisting of (NR¹R²)⁻, RO⁻, RS⁻, RCOO⁻ and phosphoraniminato groups, where R is selected from the group consisting of alkyl, alkenyl, cycloalkyl and aryl groups,
N is nitrogen and
R¹ and R² are identical or different and are selected independently from the group consisting of alkyl, aryl, heteroaryl, alkenyl groups and silicon-containing hydrocarbon radicals.

Compounds according to the invention in which L¹ is an (NR¹R²)⁻ group are advantageous.

The invention further provides a process for preparing the compounds of the formula (I), in which [V(NMe₂)₄] is reacted with one or more compounds containing ligands Q, L¹ and L².

The invention further provides for the use of the compounds of the invention for preparing a catalyst composition.

The invention further provides a catalyst composition comprising
a) one or more compounds according to the invention and
b) one or more cocatalysts.

The cocatalysts in the catalyst composition are advantageously selected from the group consisting of organometallic compounds of groups 1, 2, 12 and 13 of the Periodic Table of the Elements, IUPAC 1985 version.

As cocatalysts for the catalyst composition, it is advantageous to use aluminium compounds selected from the group consisting of ethylaluminium chloride, ethylaluminium sesquichloride, diethylaluminium chloride and mixtures of these compounds.

The catalyst composition of the invention advantageous additionally contains a promoter.

The promoter of the catalyst composition is advantageously selected from the group consisting of ethyl trichloroacetate, ethyl dichlorophenylacetate, ethyl phenyldichloroacetate and ethyl diphenylchloroacetate.

The invention further provides a process for preparing the catalyst composition, which comprises the steps
α) provision of the component a) and component b),
β) mixing of the component a) and component b) in an organic solvent.

The invention further provides a process for preparing homopolymers or copolymers of one or more olefins in the presence of the catalyst composition containing the compound of the invention.

The polymerization is advantageously carried out in solution.

The temperature during the polymerization is advantageously in the range from −100 to +150° C.

The olefins for the polymerization are advantageously selected from the group consisting of α-olefins and cycloolefins.

It is advantageous for one monomer always to be ethylene in the copolymerization.

In the preparation of an ethylene-propylene-diene polymer with the aid of a catalyst composition containing the compound of the invention, it is advantageous for the diene to be selected from the group consisting of ethylidenenorbornene, dicyclopentadiene, vinylnorbornene and mixtures of these dienes.

The composition of the invention contains at least one amido group of the type NR¹R². The radicals R¹ and R² can be identical or different and are selected independently from the group consisting of alkyl, aryl, heteroaryl, alkoxy, alkenyl groups and silicon-containing hydrocarbon radicals.

The groups R¹ and R² are preferably selected from the group consisting of C₁₋₁₀-alkyl, C₅₋₁₄-cycloalkyl, C₆₋₁₄-aryl and C₁₋₁₄-heteroaryl, C₁₋₁₀-alkoxy, C₁₋₁₄-alkenyl groups and silicon-containing hydrocarbon radicals having from 1 to 20 carbon atoms. The substituents R¹ and R² can also be joined to one another or to the ligands L¹, L² and/or Q.

For the purposes of the present invention, C₁₋₁₀-alkyl groups are all linear and/or branched alkyl radicals having from 1 to 10 carbon atoms which are known to those skilled in the art, e.g. methyl, ethyl, n-propyl, i-propyl, n-butyl, i-butyl, t-butyl, n-pentyl, i-pentyl, neopentyl, hexyl, heptyl, octyl, nonyl and decyl groups which may in turn be substituted. Possible substituents are hydrogen, halogens, nitro groups, hydroxyl groups or C₁-C₁₀-alkyl groups, and also C₅-C₁₄-cycloalkyl or C₆-C₁₄-aryl groups, e.g. benzoyl, trimethylphenyl, ethylphenyl, chloromethyl, chloroethyl and nitromethyl.

For the purposes of the present invention, C₅-C₁₄-cycloalkyl groups are monocyclic or polycyclic cycloalkyl radicals having from 5 to 14 carbon atoms which are known to those skilled in the art, e.g. cyclopentyl, cyclohexyl, cycloheptyl, cyclooctyl and cyclononyl groups or partially or fully hydrogenated fluorenyl groups, which may in turn be substituted. Possible substituents are hydrogen, halogen, nitro groups, C₁₋₁₀-alkoxy groups or C₁₋₁₀-alkyl groups, and also C₅₋₁₂-cycloalkyl or C₆₋₁₄-aryl groups, e.g. methylcyclohexyl, chlorocyclohexyl and nitrocyclohexyl.

For the purposes of the present invention, C₆-C₁₄-aryl groups are monocyclic or polycyclic aryl radicals having from 6 to 14 carbon atoms which are known to those skilled in the art, e.g. phenyl, naphthyl and fluorenyl groups. In addition, the aryl group may bear further substituents. Possible substituents are hydrogen, halogen, nitro, C₁₋₁₀-alkoxy, C₁₋₁₀-alkyl, C₅₋₁₄-cycloalkyl or C₆₋₁₄-aryl groups, e.g. bromophenyl, chlorophenyl, tolyl and nitrophenyl.

For the purposes of the present invention, C₁₋₁₄-heteroaryl groups are all monocyclic or polycyclic heterocyclic aromatics having from 1 to 10 carbon atoms which are known to those skilled in the art, e.g. thienyl, pyridyl, furanyl, pyranyl, thiazolyl, pyrrolyl, oxazolyl, isoxazolyl, pyrazolyl, imidazolyl, 1,2,3-triazolyl, 1,2,4-triazolyl, benzofuranyl, thianaphthenyl, dibenzofuranyl, indolyl, benzimidazolyl, indazolyl, quinolyl and isoquinolyl groups. In addition, the heteroaryl group may bear further substituents. Possible substituents are hydrogen, halogen, nitro, C₁₋₁₀-alkoxy, C₁₋₁₀-alkyl, C₁-C₁₀-heteroaryl, C₆₋₁₄-cycloalkyl or C₆₋₁₄-aryl, e.g. 2,4-dimethylfuran-3-yl, N-methyl-2-phenylpyrrol-4-yl groups.

For the purposes of the present invention, C₁₋₁₀-alkoxy groups are all linear or branched alkoxy radicals having from 1 to 10 carbon atoms which are known to those skilled in the art, e.g. methoxy, ethoxy, n-propoxy, i-propoxy, n-butoxy, i-butoxy, t-butoxy, n-pentoxy, i-pentoxy, neopentoxy, hexoxy, heptoxy, octoxy, nonoxy and decoxy groups which may in turn be substituted. Possible substituents are C₁-C₁₀-alkyl, C₅-C₁₄-cycloalkyl, C₆-C₁₄-aryl, and also functional groups such as chloride, bromide, iodide, fluoride, nitro and sulphonate groups.

For the purposes of the present invention, C₁₋₁₄-alkenyl groups are all linear or branched alkenyl radicals having from 2 to 14 carbon atoms which are known to those skilled in the art, e.g. ethylidene, propylidene. These may in turn be substituted. Preferred substituents are C₁-C₁₀-alkyl, C₅-C₁₄-cycloalkyl, C₆-C₁₄-aryl, and also functional groups such as chloride, bromide, iodide and fluoride.

For the purposes of the present invention, silicon-containing hydrocarbon radicals are all silicon-containing radicals having from 1 to 20 carbon atoms. Preference is given to trimethylsilyl, triethylsilyl, triisopropylsilyl, triphenylsilyl, triethoxysilyl, trimethoxysilyl, tri-tert-butylsilyl, dimethylphenylsilyl, methyldi-tert-butylsilyl. These may in turn bear substituents. Preferred substituents are C₁-C₁₀-alkyl, C₅-C₁₄-cycloalkyl, C₆-C₁₄-aryl, and also functional groups such as chloride, bromide, iodide and fluoride.

The compounds of the invention contain monodentate ligands L¹ and/or L². For the purposes of the present invention, monodentate ligands are all singly negatively charged ligands known to those skilled in the art. Preference is given to halides, amido groups of the type (NR¹R²)⁻, RO⁻, RS⁻, RCOO⁻ and phosphoraniminato groups of the type (—NPX₃)⁻, where R is selected from the group consisting of alkyl, alkenyl, cycloalkyl and aryl groups.

Particularly preferred monodentate ligands are fluoride, chloride, bromide, iodide, amido groups of the type (NR¹R²)⁻, phosphoraniminato groups of the type (—NPX₃)⁻, and RO⁻ with R selected from the group consisting of C₁-C₁₀-alkyl and C₆-C₁₄-aryl groups. The radicals R¹ and R² are selected independently from the group consisting of C₁₋₁₀-alkyl, C₅₋₁₄-cycloalkyl, C₆₋₁₄-aryl and C₁₋₁₄-heteroaryl, C₁₋₁₀-alkoxy, C₁₋₁₄-alkenyl groups and silicon-containing hydrocarbon radicals having from 1 to 20 carbon atoms. The radicals R¹ and R² can also be joined to one another or to ligands L¹, L² and/or Q. In the case of R¹ and/or R², very particular preference is given to amido groups of the type NR¹R².

For the purposes of the present invention, C₆-C₁₄-aryloxy groups are all monocyclic or polycyclic oxyaryl radicals having from 6 to 14 carbon atoms which are known to those skilled in the art. Preference is give to phenoxide, naphthoxide and binaphthoxide groups. In addition, the aryl group may bear further substituents. Possible substituents are hydrogen, halogens, nitro, C₁₋₁₀-alkoxy, C₁₋₁₀-alkyl, C₅₋₁₄-cycloalkyl or C₆₋₁₄-aryl groups. Preference is given to bromophenyl, chlorophenyl, tolyl and nitrophenyl.

As a person skilled in the art will know, phosphoraniminato compounds of the type (—NPX₃)⁻ are compounds bearing monodentate singly anionically charged ligands or substituents of the type: 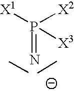
where X¹, X², X³ are identical or different and are selected independently from the group consisting of C₁₋₁₀-alkyl, C₅₋₁₄-cycloalkyl, C₆₋₁₄-aryl, C₁₋₁₀-alkoxy groups which may be joined to one another and/or to the other ligands of the vanadium compound. Expressly included are iminophosphoranes in which one or more substituents of the phosphorus are bound to the phosphorus via heteroatoms such as N, O, S. The bond between phosphorus and the heteroatom(s) can be single and/or double; in the case of a double bond between phosphorus and heteroatom, the phosphorus centre bears, apart from the imido group and the group bound by the heteroatom, only one further, singly bound substituent. The heteroatom(s) can bear one or more further substituents which can be identical or different and are selectged independently from the group consisting of C₁₋₁₀-alkyl, C₆₋₁₄-aryl, C₁₋₁₀-alkoxy groups. Preferred phosphoraniminato groups are iminotris(dimethylamino)phosphorane, iminobis(dimethylamino)phenylphosphorane, imino(dimethylamino)di(n-butyl)phosphorane, iminotris(N-anilino)phosphorane, iminotris(methoxy)phosphorane, iminodi(methoxy)(n-butyl)phosphorane, imino(amino)di(phenyl)phosphorane.

The substituent Q is likewise a monodentate ligand selected from the group of monodentate ligands L¹ and L², with halogens and amido groups of the type (NR¹R²)⁻ being excluded for Q. Preferred monodentate ligands Q are RO⁻ groups in which R is selected from the group consisting of methyl, ethyl, propyl, isopropyl, butyl, tert-butyl, phenyl, 2,6-dimethylphenyl, 2,4,6-trimethylphenyl, 2,6-dibromophenyl, 2,6-diiodophenyl, 2,6-dichlorophenyl, 2,6-diisopropylphenyl, 2,4,6-tribromophenyl, 2,4,6-trichlorophenyl, 2,4,6-triiodophenyl, 2,4,6-triisopropylphenyl, 2,6-diphenylphenyl, 3,5-di-tert-butylphenyl, 2,4-di-tert-butylphenyl.

The central metal ion of the compound of the invention is vanadium in the oxidation state +III or +IV.

The indices x, y, z depend on the oxidation state of the vanadium. x is preferably 2 for a vanadium atom in the oxidation state +IV. In the case of a vanadium atom in the oxidation state +III, x is preferably 1.

In the case of vanadium in the oxidation state +IV, the compounds having structures of the formula (II)

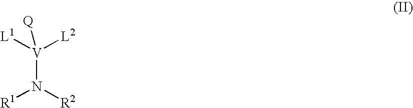

In the case of vanadium in the oxidation state +III, the compounds having structures of the formula (III)

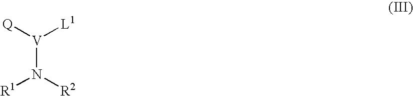

In addition, the compounds of the invention can optionally contain one or more further uncharged ligands such as tetrahydrofuran, 1,2-dimethoxyethane, phosphines, diphosphines, imines, diimines in the coordination sphere of the vanadium. These can, if desired, also be bound to one or more of the ligands Q, L¹, L², R¹ and/or R².

The invention further provides catalyst compositions comprising one or more of the compounds of the invention and one or more cocatalysts. For the purposes of the present invention, cocatalysts are all organometallic compounds of groups 1, 2, 12 or 13 of the Periodic Table of the Elements, IUPAC 1985 version, in which at least one hydrocarbon group of the cocatalyst is bound directly via a carbon atom to the metal atom of the compound of the invention.

Preferred organometallic compounds are compounds of aluminium, sodium, lithium, zinc and magnesium. Particular preference is given to those of aluminium.

The hydrocarbon group which is bound the metal atom of the compound of the invention is preferably a C₁₋₁₀-alkyl group. Preferred cocatalysts are amylsodium, butyllithium, diethylzinc, butylmagnesium chloride, dibutylmagnesium and aluminium compounds. Particularly preferred aluminium compounds are trialkylaluminium compounds, aluminoxanes, alkylaluminium hydrides such as diisobutylaluminium hydride, alkylalkoxyaluminium compounds, alkylaryloxyaluminium compounds, aluminoxanes and halogen-containing aluminium compounds such as diethylaluminium chloride, diisobutylaluminium chloride, ethylaluminium chloride or ethylaluminium sesquichloride. It is also possible to use mixtures of these components.

The molar ratio of cocatalyst to compound according to the invention can be varied within a wide range. The molar ratios of central atom of the cocatalyst to the vanadium of the compound of the invention are used for determining the molar ratio. In general, it will be in the range from 1:1 to 5000:1. Preference is given to the range from 1:1 to 500:1, and very particular preference is given to the range from 2:1 to 100:1.

The composition containing at least one compound according to the invention is prepared by mixing with one or more cocatalysts in an organic solvent. For the purposes of the present invention, organic solvents are all organic solvents which contain 3 or more carbon atoms or mixtures of these solvents. Preference is given to propane, butane, pentane, hexane, cyclohexane, benzene, toluene and octane.

The composition is suitable as catalyst. In particular, the composition is suitable as catalyst for the polymerization of olefins, in particular the copolymerization of ethene/propene or ethene/α-olefin and the terpolymerization of these monomers with dienes.

Preferred olefins are ethene, propene, isobutene, 1-butene, 2-butene, 1-hexene, 1-octene, 4-methyl-1-pentene, unsaturated alicyclic compounds such as cyclopentene and/or norbornene. In the case of terpolymerization, preference is given to using dienes as third monomer in addition to ethene and α-olefins. Preferred dienes are 1,2-butadiene, 1,3-butadiene, isoprene, ethylidenenorbornene, vinylnorbornene, dicyclopentadiene and 1,4-hexadiene.

The polymerization is preferably carried out by bringing the olefins into contact with the composition containing at least one compound according to the invention as a solution in a suitable solvent, in gaseous form, finely dispersed in liquid form or suspended in a liquid diluent. The catalysts are generally used in amounts in the range from 10⁻¹⁰ to 10⁻¹ mol % per mol of monomer (total monomer concentration).

Suitable solvents are all organic solvents. Preference is given to aliphatic and aromatic solvents and suspension media having 3 or more carbon atoms and also mixtures of these substances. Particular preference is given to propane, butane, pentane, hexane, cyclohexane, benzene, toluene and octane.

Further gases or finely dispersed liquids can be mixed into the gaseous, liquid or sprayed monomers for the purposes of dilution, spraying or heat removal.

The composition containing at least one compound according to the invention can be modified by the additives referred to as promoters which are known to those skilled in the art and increase the productivity of the catalyst and/or alter the properties of the polymer obtained.

As activity-increasing additives or promoters, preference is given to using halogen-containing compounds, in particular halogen-containing hydrocarbons. Said hydrocarbons can contain further heteroatoms such as oxygen, nitrogen, phosphorus and sulphur. Particular preference is given to compounds which contain few halogens (from 1 to 3 atoms per molecule), since the halogen concentration in the polymer can be kept low in this way. Very particular preference is given to alkyl and alkoxyalkyl esters of phenylchloroacetic acid, diphenylchloroacetic acid, phenyldichloroacetic acid and trichloroacetic acid.

As additives which increase the activity and/or regulate the molecular weight, which are likewise referred to as promoters, it is possible to use Lewis acids such as AlCl₃, BCl₃ or SiCl₄ or Lewis bases such as esters, amines, ammonia, ketones, alcohols, ethers. Furthermore, the polymerization can be carried out in the presence of hydrogen.

Mixtures of the activity-increasing additives mentioned are expressly also included.

It can be advantageous to apply the composition containing at least one compound according to the invention as catalyst system to a support.

As support materials, preference is given to using particulate, organic or inorganic solids whose pore volume is from 0.1 to 15 ml/g, preferably from 0.25 to 5 ml/g, whose specific surface area is greater than 1, preferably from 10 to 1000 m²/g (BET), whose particle size is from 10 to 2500 μm, preferably from 50 to 1000 μm, and whose surface may be modified in a suitable way.

The specific surface area is determined in a customary manner in accordance with DIN 66 131, the pore volume is determined by the centrifugation method described by McDaniel in J. Colloid Interface Sci. 1980, 78, 31, and the particle size is determined as described by Cornillaut in Appl. Opt. 1972, 11, 265.

Preferred inorganic solids are silica gels, precipitated silicas, clays, aluminosilicates, talc, zeolites, carbon black, inorganic oxides such as silicon dioxide, aluminium oxide, magnesium oxide, titanium dioxide, inorganic chlorides such as magnesium chloride, sodium chloride, lithium chloride, calcium chloride, zinc chloride, or calcium carbonate. The inorganic solids mentioned which satisfy the abovementioned specification and are therefore particularly suitable for use as support materials are, for example, described in more detail in Ullmanns Enzyklopädie der technischen Chemie, volume 21, pp. 439-483 (silica gels), volume 23, pp. 311-331 (clays), volume 14, pp. 633-651 (carbon black) and volume 24, pp. 575-578 (zeolites).

Suitable organic solids are pulverulent, polymeric materials, preferably in the form of free-flowing powders, having the abovementioned properties. Examples which may be mentioned, without restricting the present invention, are: polyolefins such as polyethene, polypropene, polystyrene, polystyrene-co-divinylbenzene, polybutadiene, polyethers such as polyethylene oxide, polyoxytetramethylene or polysulfides such as poly-p-phenylene sulphide. Particularly suitable materials are polypropylene, polystyrene or polystyrene-co-divinylbenzene. The abovementioned organic solvents which satisfy the abovementioned specification and are therefore particularly suitable for use as support materials are described in more detail in, for example, Ullmanns Enzyklopädie der technischen Chemie, volume 19, pp. 195-210 (polypropylene), and volume 19, pp. 265-295 (polystyrene).

The preparation of the supported catalyst system can be carried out in a wide temperature range. In general, the temperature is between the melting point and boiling point of the inert solvent mixture. The lower temperature limit is usually −50° C., preferably −20° C., very particularly preferably +20° C., and the upper temperature limit is +200° C., preferably +100°, very particularly preferably +60° C.

### EXAMPLES

All syntheses described below were carried out under an Ar atmosphere.

### Example 1

Synthesis of [V(N(CH₃)₂)₄] (Catalyst 1: Comparative Example)

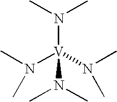

At 0° C., 20 g of vanadium oxytrichloride VOCl₃ dissolved in 50 ml of hexane were added dropwise via a dropping funnel to a suspension of 30.8 g of lithium dimethylamide LiN(CH₃)₂ in 200 ml of hexane. The first 3 ml were added quickly, and the dropwise addition rate was subsequently kept very low in order to avoid heating to >10° C. After the addition of the VOCl₃ solution was complete, the green suspension was warmed to room temperature, stirred for 1 hour and subsequently refluxed for 4 hours. The mixture was cooled and the Li salts were filtered off. The solvent was subsequently distilled off at 4*10⁻² bar. The product was purified by sublimation at not more than 80° C. and 2*10⁻⁴ bar.

Yield: 24.3 g (92%)

Melting point: 112° C. (decomposition)

C₈H₂₄N₄V (227.25 g/mol): C: 44.22 (calc.: 42.26); H: 9.98 (calc.: 10.65); N: 23.87 (calc.: 24.66)
Synthesis of Me₃SiNP(tBu)₃ (Using a Method Based on that of H. Schmidbaur, G. Blaschke, Z. Naturforsch. 1978, 33b, 1556-1559)

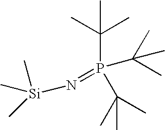

57.6 ml of trimethylsilyl azide were added dropwise via a dropping funnel to a mixture of 80.8 g of tri(tert-butyl)phosphine and 0.8 g of anhydrous aluminium trichloride at 140° C. while stirring. The dropwise addition rate is regulated so that the internal temperature does not exceed 170° C. and controlled nitrogen evolution is observed. After addition of the azide is complete, the slightly yellowish melt is heated and refluxed for 8 hours. It is subsequently sublimed at 100° C. and 6*10⁻² bar. The product is obtained in the form of colourless needles.

Yield: 112.7 g (97%)

Melting point: 132° C.

¹H-NMR (200 MHz, CDCl₃): δ=0.02 (s, 9H, Si(CH₃)₃), 1.21 (d, ³J_{PH}=12.7 Hz, 27H, C(CH₃)₃) ppm.

¹³C-NMR (50 MHz, CDCl₃): δ=27.3 (C(CH₃)₃), 46.2 (d, ²J_{PC}=42.2 Hz, PC(CH₃)₃)

³¹P-NMR (81 MHz, CDCl₃): 29.3 ppm
Synthesis of [V(NP(tBu)₃)Cl₃]₂

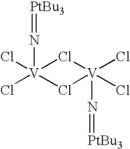

A solution of 1.0 g of Me₃SiNP(tBu)₃ in 5 ml of toluene was admixed with 0.67 g of VCl₄ in 20 ml of toluene with exclusion of light while stirring and cooling in an ice bath (0° C.). The black reaction mixture was stirred at 0° C. for 2 hours and then warmed to room temperature over a period of 30 minutes. A reddish brown suspension was formed, and this is filtered. The light-sensitive reddish brown powder is separated off by filtration and dried under reduced pressure.

Yield: 610 mg (54%)

Melting point: 147° C. (decomposition)

C₂₄H₅₄Cl₆N₂P₂V₂ (764.24 g/mol)

IR (Nujol) ν[cm⁻¹]: 2073 w, 1379 m, 1261 m, 1240 w, 1049 m, 970 s, 939 m, 825 m, 746 m, 671 m, 644 s, 553 m

ESI-MS m/e: 373 (C₁₂H₂₇Cl₃NPV⁺), 217, 147, 93, 41

Synthesis of HNP(tBu)₃ (Using a Method Based on that of H. Schmidbaur. G. Blaschke, Z. Naturforsch. 33b (1978) 1556-1559)

30 g of ^{t}Bu₃PN—SiMe₃ are admixed with 25 ml of toluene and 50 ml of methanol and also one drop of H₂SO₄ (conc.). The reaction solution is stirred at 60° C. for 36 hours. After the signal δ_{P}=34 has been completely replaced by the new signal δ_{P}=59 (³¹P-NMR monitoring of the reaction solution), the solvent is completely removed by evaporation and the white residue which remains is extracted with hot pentane. The product is crystallized from the concentrated pentane extract at −80° C.

Yield: 19.82 g (88%) of white solid

¹H-NMR (200.1 MHz, C₆D₆): δ=1.20 (d, ³J_{P-H}=12.3 Hz, 27H, PC(CH₃)₃) ppm.

¹³C-NMR (50.3 MHz, C₆D₆): δ=29.6 (s, C(CH₃)₃), 39.2 (d, ¹J_{P-C}=45.4 Hz, PCMe₃) ppm.

³¹P-NMR (81.0 MHz, C₆D₆): δ=57.6 (s, NP^{t}Bu₃) ppm.

Synthesis of LiNP(tBu)₃:

2.17 g of HNP(tBu)₃ are dissolved in 30 ml of hexane. At 0° C., 10 ml of a solution of nBuLi (1M in hexane) are added thereto over a period of 3 minutes. The mixture is warmed to 25° C. and the solvent is completely removed by evaporation after 30 minutes. The colourless, light-sensitive residue is washed with pentane and dried under reduced pressure.

Yield quantitative, intermediate used as obtained.
Synthesis of [V(NP(tBu)₃)₂Cl₂] (Catalyst 2: Comparative Example)

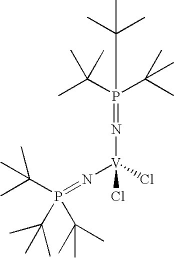

20 ml of argon were condensed onto 446 mg of Li(NP(tBu)₃) and 373 mg of [V(NP(tBu)₃)Cl₃]₂ while cooling by means of liquid N₂. 20 ml of toluene were then slowly added dropwise. The reaction mixture was shielded from light and stirred at 0° C. for 5 hours and subsequently warmed to room temperature. A reddish brown solution containing a suspended solid was formed. The solid is filtered off and the filtrate is evaporated to dryness under reduced pressure. The product is obtained as a reddish brown solid.

Yield: 391 mg (36%)

Melting point: 78° C. (decomposition)

C₂₄H₅₄Cl₂N₂P₂V (554.50 g/mol): C: 49.33 (calc.: 51.99); H: 5.43 (calc.: 5.05); N: 10.16 (calc.: 9.82)

IR (Nujol) ν[cm⁻¹]: 2671 w, 1305 m, 1259 m, 1182 s, 1026 m, 848 m, 798 s, 725 s, 688 m, 617 m, 593 m.

EI-MS m/e: 554 (M+), 373, 218, 147, 93, 41.
Synthesis of [V(NP(tBu)₃)₂(NMe₂)₂] (Catalyst 3)

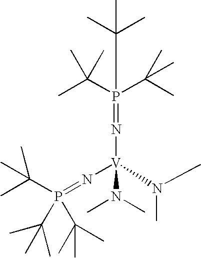

At 0° C., 300 mg of [V(NMe₂)₄] were reacted with 574 mg of HNP(tBu)₃ in 15 ml of hexane. After 1 hour, the green solution was warmed to room temperature and the solvent was subsequently distilled off under reduced pressure. The green solid was taken up in 4 ml of hexane and crystallized from this solution at −20° C. over a period of 48 hours. The scale-like crystals were filtered off and dried under reduced pressure.

Yield: 423 mg (74%)

Melting point: 112° C.

C₂₈H₆₆N₄P₂V (571 g/mol): C: 55.21 (calc.: 58.82); H: 10.82 (calc.: 11.64); N: 9.05 (calc.: 9.80)

IR (Nujol) ν[cm⁻¹]: 2751 s, 1386 m, 1356 s, 1205 s, 1143 s, 951 m, 806 s, 576 m, 494 s

EI-MS m/e: 218, 161, 104, 57, 48
Synthesis of [V(NP(Ph)₃)₂(NMe₂)₂] (Catalyst 4)

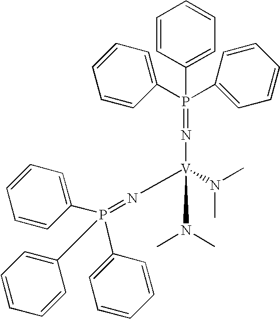

20 ml of argon were condensed into a mixture of 100 mg of [V(NMe₂)₄] and 244 mg of Ph₃PNH while cooling by means of liquid N₂. 30 ml of hexane were subsequently added, resulting in the argon being given off and a deep green solution being formed. The mixture was stirred at room temperature for 2 hours and subsequently refluxed for 4 hours. After evaporation to a volume of 3 ml, it was cooled to −18° C. A deep green solid precipitated and was filtered off.

Yield: 237 mg (78%)

Melting point: 132° C.

C₄₀H₄₂N₄P₂V (691.69 g/mol): C: 67.22 (calc.: 69.46); H: 5.88 (calc.: 6.12); N: 8.20 (calc.: 8.10)

IR (Nujol) ν[cm⁻¹]: 2926 s, 2855 s, 2359 m, 1462 s, 1377 m, 1261 s, 1111 s, 804 s, 622 m, 534 m, 411 s

EI-MS m/e: 691 (M+), 277, 262, 201, 185, 108, 45
Synthesis of [V(—O-2,4,6-C₆H₂I₃)₂(NMe₂)₂] (Catalyst 5)

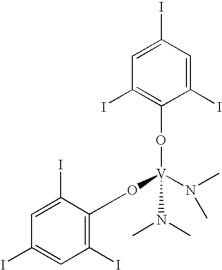

At −10° C., 300 mg of [V(NMe₂)₄] were reacted with 1.37 g of 2,4,6-triiodophenol in 15 ml of hexane with exclusion of light. The mixture was stirred at −10° C. for 3 hours and then warmed to room temperature. It is subsequently filtered and the filtrate is freed of the solvent under reduced pressure. The red solid obtained in this way was taken up in 2 ml of hexane and the solution was stored at −83° C. for 48 hours. The solid which precipitated was filtered off and dried under reduced pressure.

Yield: 883 mg (62%)

Melting point: 140° C. (decomposition)

C₁₆H₁₆I₆N₂O₂V (1080.68 g/mol): C: 18.43 (calc.: 17.77); H: 1.83 (calc.: 1.43); N: 2.67 (calc.: 2.59)

IR (Nujol) ν[cm⁻¹]: 2854, 1462 w, 1413 m, 1240 s, 1143, 1037 w, 950 m, 871 m, 856 m, 798 m, 455 s

EI-MS m/e: 472.5, 345, 218, 91, 63, 45
Synthesis of [V(—O-2,4,6-C₆H₂I₃)₃(NMe₂)] (Catalyst 6)

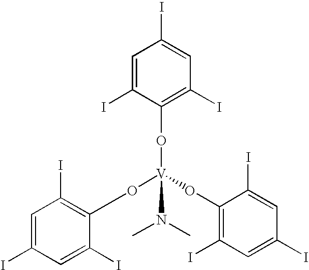

At −20° C., 300 mg of [V(NMe₂)₄] and 2.05 g of 2,4,6-triiodophenol were reacted in 30 ml of hexane with exclusion of light. The mixture was warmed to room temperature and stirred for 24 hours. The red solid obtained is filtered off and recrystallized from hot benzene.

Yield: 1.51 g (78%)

Melting point: 143° C. (decomposition)

C20H1219NO3V: C: 17.11 (calc.: 16.94); H: 1.21 (calc.: 0.83); N: 0.78 (calc.: 0.93)

IR (Nujol) ν[cm⁻¹]: 2768, 2361 w, 2341 w, 1504 w, 1205 s, 1037 w, 951 m, 847 m, 723 m, 453 s

EI-MS m/e: 472.5, 345, 218, 91, 63, 45
Synthesis of [V(—O-2,6-iPr₂(C₆H₃))₂(NMe₂)₃] (Catalyst 7)

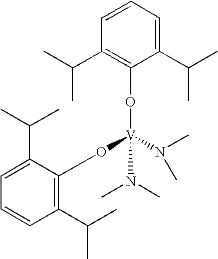

300 mg of [V(NMe₂)₄] were dissolved in 30 ml of hexane and admixed at −20° C. with 520 mg of 2,6-diisopropylphenol in 15 ml of hexane. The mixture was warmed to room temperature and filtered. The filtrate was evaporated to 5 ml and stored at −83° C. for 48 hours. The red, microcrystalline solid which precipitated is filtered off and dried under reduced pressure.

Yield: 384 mg (78%)

Melting point: 126° C.

IR (Nujol) ν[cm⁻]: 2854, 1547 w, 1362 m, 1238 s, 1201 m, 1020 w, 949 m, 912 m, 868 s, 794 m, 722 m, 606 s
Synthesis of [V(—O-2,6-iPr₂(C₆H₃))₃(NMe₂)] (Catalyst 8)

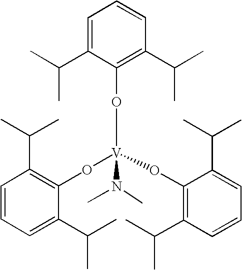

245 mg of 2,6-diisopropylphenol were added at 0° C. to a solution of 104 mg of [V(NMe₂)₄] in 30 ml of hexane. The mixture was stirred at 0° C. for 2 hours and subsequently at room temperature for 2 hours. It was filtered and the filtrate was freed of the solvent under reduced pressure. This leaves a reddish brown solid.

Yield: 232 mg (81%)

Melting point: 128° C., C₃₈H₅₇NO₃V (626.82 g/mol): C: 70.81 (calc.: 72.82); H: 9.47 (calc.: 9.17), N: 2.73 (calc.: 2.23)

IR (Nujol) ν[cm⁻¹]: 2922 vs, 2854 w, 2361 vw, 2340 w, 1585 s, 1460 w, 1433 s, 1378 s, 1325 m, 1255 m, 1194 m, 1110 w, 1042 vw, 948 w, 897 m, 873 w, 848 w, 795 w, 751 m, 715 w, 612 vw

FD-MS m/e: 627(M+), 599, 512, 45
Synthesis of [V(—O-2,6-Ph₂(C₆H₃))(NMe₂)₃] (Catalyst 9)

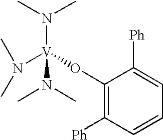

300 mg of [V(NMe₂)₄] were reacted with 358 mg of 2,6-diphenylphenol in 10 ml of hexane at −20° C. with exclusion of light. The reaction mixture was subsequently warmed to 40° C. and filtered warm. The filtrate was evaporated to 2 ml and the brown solid which precipitated was subsequently filtered off and dried under reduced pressure.

Yield: 421 mg (74%)

Melting point: 128° C. (decomposition)

C₂₄H₃₁N₃OV (428.47 g/mol): C: 66.23 (calc.: 67.28); H: 7.01 (calc.: 7.29); N: 9.40 (calc.: 9.81)

IR (Nujol) ν[cm⁻¹]: 2361 m, 1564 m, 1261 m, 1220, 1083 m, 968 m, 949 m, 887 m, 756 s, 746 m, 700 s, 623 m

EI-MS m/e: 246, 227, 226, 217, 215, 202, 57, 45

Synthesis of [V(—O-2,6-Ph₂(C₆H₃))₂(NMe₂)₂] (Catalyst 10)

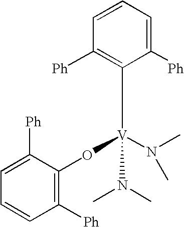

300 mg of [V(NMe₂)₄] were reacted with 719 g of 2,6-diphenylphenol in 10 ml of hexane at −20° C. with exclusion of light. The reaction mixture was subsequently warned to 40° C. and filtered warm. The filtrate was evaporated to dryness under reduced pressure, the residue was admixed with 3 ml of pentane, the compound was recrystallized at −80° C. and separated from the mother liquor.

Yield: 666 mg (81%) of brown solid.

Melting point: 141° C.

C₄₀H₃₂N₂O₂V (623.65 g/mol): C: 75.60 (calc.: 77.04); H: 5.59 (calc.: 5.17); N: 4.11 (calc.: 4.49)

IR (Nujol) ν[cm⁻¹]: 2361 m, 1597 m, 1579 m, 1671 m, 1278 m, 1240 s, 1086 m, 1070 m, 949 m, 887 m, 862 m, 756 s, 746 m, 700 s, 632 m

EI-MS m/e: 246, 227, 226, 217, 215, 202, 57, 45

Synthesis of [V(—O-2,6-Ph₂(C₆H₃))₃(NMe₂)] (Catalyst 11)

300 mg of [V(NMe₂)₄] were reacted with 1073 mg of 2,6-diphenylphenol in 10 ml of hexane at −20° C. with exclusion of light. The reaction mixture was subsequently warmed to 40° C. and filtered warm. The filtrate was evaporated todryness under reduced pressure, the residue was admixed with 3 ml of pentane, the compound was crystallized at −80° C. and separated from the mother liquor.

Yield: 780 mg (74%) of brown solid

Melting point: 143° C.

C₅₆H₄₅NO₃V (623.65 g/mol): C: 80.20 (calc.: 80.95); H: 5.59 (calc.: 5.46); N: 1.41 (calc.: 1.69)

IR (Nujol) ν[cm⁻]: 2853 m, 1460 m, 1371 m, 1261 m, 1085 m, 1024 s, 874 m, 843 m, 802 m, 755 m, 722 m, 703 m

FD-MS m/e: 826 (M+), 246, 46
Synthesis of [V(—O-2,4-tBU(C₆H₃))₂(NMe₂)₂] (Catalyst 12)

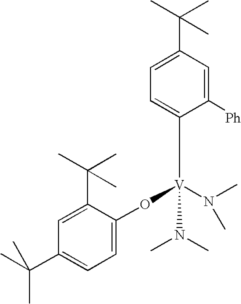

At room temperature, 300 mg of [V(NMe₂)₄] were reacted with 597 mg of 2,4-di(tert-butyl)phenol in 10 ml of hexane with exclusion of light. The mixture was subsequently refluxed for 3 hours, resulting in formation of a deep red solution. The solution was filtered hot and subsequently freed of the solvent under reduced pressure. A bronze-coloured, microcrystalline solid was obtained.

Yield: 442 mg (62%)

Melting point: 162° C.

C₃₂H₅₄N₂O₂V (549.73 g/mol):

C: 67.91 (calc.: 69.92); H: 9.60 (calc.: 9.90); N: 5.74 (calc.: 5.10)

IR (Nujol) ν[cm⁻¹]: 2361 m, 2341 m, 1529 w, 1485 vs, 1377 m, 1361 s, 1238 s, 1103 m, 1087 s, 912 m, 844 s

EI-MS: 206, 191, 163, 57, 45
Synthesis of [V{3,3′,3″, 3′″-(CF₃C₆H₆)₄C₂H₂O₂}(NMe₂)₂] (Catalyst 13)

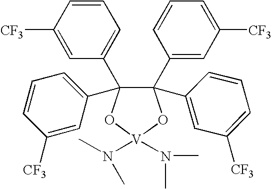

At −30° C., 300 mg of [V(NMe₂)₄] were reacted with 0.92 g of 3,3′,3″,3″′-tetrakis(trifluoromethyl)benzopinacol in 10 ml of hexane. After 2 hours, the mixture was warmed to 40° C. until a deep blue solution was formed. The solvent was subsequently distilled off under reduced pressure and the blue product was taken up in 20 ml of toluene. At −20° C., the product precipitated as a reddish brown solid after 24 hours.

Yield: 654 mg (64%)

Melting point: 171° C.

C₃₄H₂₈F₁₂N₂O₂V: C: 51.31 (calc.: 52.64); H: 3.41 (calc.: 3.64); N: 3.11 (calc.: 3.61)

IR (Nujol) ν[cm⁻¹]: 3753 w, 2723 w, 2172 m, 1512 m, 1291 s, 1173 s, 1071 w, 803 m, 768 m

EI-MS m/e: 775 (M+), 634
Synthesis of [V(3,5-tBu₂C₆H₂O₂)(NMe₂)₂] (Catalyst 14)

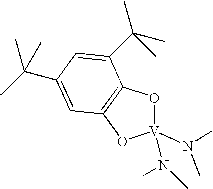

At −30° C., 300 mg of [V(NMe₂)₄] were reacted with 320 mg of 3,5-di(tert-butyl)orthoquinone in 10 ml of hexane. After 2 hours, the mixture was heated to 60° C. and subsequently filtered hot. The filtrate was evaporated to 3 ml under reduced pressure. After 48 hours at −48° C., a dark blue solid precipitated and was filtered off and dried.

Yield: 330 mg (64%)

Melting point: 171° C.

C₂₀H₂₆N₂O₂V (377.14 g/mol): C: 63.30 (calc.: 63.64); H: 8.84 (calc.: 6.95); N: 6.50 (calc.: 7.43)

IR (Nujol) ν[cm⁻¹]: 2329 w, 1589 m, 1377 s, 1261 s, 1093 w, 1026 m, 987 s, 918 m
Synthesis of [V(—O-2,6-Cl₂(C₆H₃))₂(NMe₂)₂] (Catalyst 15)

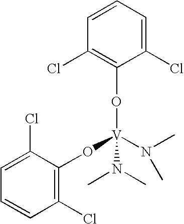

300 mg of [V(NMe₂)₄] were reacted with 420 mg of 2,6-dichlorophenol in 10 ml of hexane at −20° C. with exclusion of light. The reaction mixture was subsequently warmed to 40° C. and, after a further 3 hours, filtered at 40° C. The filtrate was evaporated to dryness under reduced pressure, the residue was admixed with 3 ml of pentane, the compound was crystallized at −80° C. and separated from the mother liquor.

Yield: 465 mg (76%) of brown solid.

Decomp. >130° C.

C₁₆H₁₈Cl₄N₂O₂V (462.90 g/mol): C: 42.13 (calc.: 41.48); H: 4.22 (calc.: 3.89); N: 5.91 (calc.: 6.05)

FD-MS (toluene) m/e: 463 (M+)

Copolymerization of Ethene/Prolpene

The apparatus which is maintained at 40° C. by means of a thermostat is evacuated to 5*10⁻² bar for 30 minutes. It is then pressurized to a pressure of 1.5 bar by means of repurified propene. 40 ml of absolute hexane and 0.408 mmol (18.5 eq) of a 15% strength solution of ethylaluminium sesquichloride in heptane are introduced into the autoclave in a countercurrent of propene. The apparatus is subsequently closed under a propene atmosphere in order to fill a pressure syringe with 50 ml of hexane and 0.096 mmol (4.4 eq) of ethyl dichlorophenylacetate in a countercurrent of propene.

0.022 mmol (1.0 eq) of the vanadium precursor compound dissolved in 30 ml of hexane are then introduced into the stirred vessel. The hexane solution is saturated with propene at 3.7 bar for 15 minutes. After the propene feed has been shut off, the total pressure is set to 5.5 bar by means of repurified ethene. The reaction is started at 40° C. by injection of the reactivator by means of the pressure syringe. The reaction mixture is stirred by means of an anchor stirrer at 1000 rpm under a constant ethene pressure of 5.5 bar.

After 10 minutes, the reaction is stopped by dropwise introduction of the mixture into methanol which has been acidified with hydrochloric acid. After the polymer precipitate has been washed with ethanol, it is dried at 50° C. for 10 hours and the yield is determined.

TABLE 1
Results of the copolymerization of ethene/propene
by means of vanadium catalysts

| | Yield | Tmax*) |
|---|---|---|
| Catalyst | [g] | [° C.] |
| VCl₄ | 4.1 | 59 |
| Catalyst 1 | 4.5 | 52 |
| Catalyst 2 | 5.7 | 58 |
| Catalyst 3 | 16.7 | 52 |
| Catalyst 5 | 6.5 | 53 |
| Catalyst 6 | 8.2 | 52 |
| Catalyst 8 | 9.5 | 50 |
| Catalyst 9 | 7.9 | 57 |
| Catalyst 10 | 7.3 | 54 |
| Catalyst 11 | 4.3 | 52 |
| Catalyst 12 | 10.2 | 51 |
| Catalyst 13 | 5.9 | 52 |

*)the reaction is exothermic and heats the reaction mixture; the maximum reaction temperature is reported

Comparison of the polymerization results shown in Table 1 clearly shows that the polymerization activity of the novel catalyst systems is, due to appropriate choice of the ligands, superior to the known systems such as VCl₄, catalyst 1. The positive effect produced by the replacement of chloro ligands by amido ligands can clearly be seen from comparison of catalyst 2 with catalyst 3.

EPDM Synthesis

An autoclave which has been made inert is charged with 1500 ml of hexane and 6.0 g of ethylidenenorbomene and heated to the polymerization temperature of 40° C. Ethene and propene in a ratio of 1:19 are then injected to a pressure of 7 bar. The catalyst components (0.05 mmol of V component, 1 mmol of ethylaluminium sequichloride and 0.25 mmol of ethyl dichlorophenylacetate) are simultaneously introduced into the reactor via pressure burettes and polymerization is then carried out at a pressure of 7.0 bar. Regulation is effected by introduction of ethene. After half an hour, the experiment is stopped and the mixture is transferred to a container filled with ethanol. The polymer is dried at 80° C. in a vacuum drying oven.

TABLE 2
Results of the terpolymerization of ethene/propene/ethylidenenorbornene
by means of vanadium catalysts

| | Yield | E | P | ENB | T_{g} | | |
|---|---|---|---|---|---|---|---|
| Catalyst | [g] | [wt %] | [wt %] | [wt %] | [° C.] | M_{w} | M_{w}/Mₙ |
| O═VCl₃ | 22.4 | 45.8 | 43.1 | 11.1 | −43 | | |
| Catalyst 12 | 36.0 | 49.8 | 41.2 | 9.0 | −47 | 225000 | 1.7 |
| Catalyst 14 | 26.8 | 48.0 | 41.2 | 10.8 | −45 | 208000 | 1.8 |
| Catalyst 15 | 25.2 | 51.3 | 38.2 | 10.6 | −46 | 233000 | 1.6 |

As can be seen from Table 2, all 3 catalysts tested display a significantly increased polymerization activity in the polymerization of ethene/propene/ethylidenenorbornene. The pQlymers also display a slightly altered microstructure and, as a result, lower glass transition temperatures.

1. Compounds of the formula (I)
QL¹_{y}L²_{z}V(NR¹R²)ₓ (I)
where
V is vanadium in the oxidation state +III or +IV,
Q is a ligand selected from the group of monodentate ligands, with halides and amido groups of the type (NR¹R²)⁻ being excluded as monodentate ligand for Q,
L¹ and L² are identical or different and are selected independently from the group consisting of monodentate ligands, where
y is 0 r 1,
z is 0 or 1 and the sum of x, y and z is 2 when the oxidation state of vanadium is +III and the sum of x, y and z is 3 when the oxidation stage of vanadium is +IV,
N is nitrogen,
R¹ and R² are identical or different and are selected independently from the group consisting of alkyl, aryl, heteroaryl, alkenyl groups and silicon-containing hydrocarbon radicals, where
x can be an integer from 1 to 3 when the oxidation state of vanadium is +IV and can be 1 or 2 when the oxidation state of vanadium is +III.

2. Compounds according to claim 1 having the formula (II) 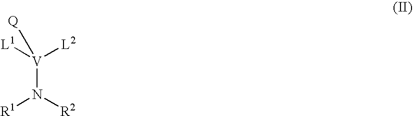
where
V is vanadium in the oxidation state +IV,
Q is a ligand selected from the group of monodentate ligands, with halides and amido groups of the type (NR¹R²)⁻ being excluded as monodentate ligand for Q,
L¹ and L² are identical or different and are selected independently from the group consisting of (NR¹R²)⁻, RO⁻, RS⁻, RCOO⁻ and phosphoraniminato groups, where R is selected from the group consisting of alkyl, alkenyl, cycloalkyl and aryl groups,
N is nitrogen and
R¹ and R² are identical or different and are selected independently from the group consisting of alkyl, aryl, heteroaryl, alkenyl groups and silicon-containing hydrocarbon radicals.

3. Compounds according to either claim 1 or 2 in which L¹ or L² is a (NR¹R²)⁻ group.

4. Compounds according to any of claims 1 to 3 in which L¹ and L² are identical or different (NR¹R²) groups.

5. Compounds according to claim 1 having the formula (III) 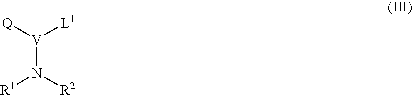
where
V is vanadium in the oxidation state +III,
Q is a ligand selected from the group of monodentate ligands, with halides and (NR¹R²)⁻ groups being excluded as monodentate ligand for Q,
L¹ is selected from the group consisting of (NR¹R²)⁻, RO⁻, RS⁻, RCOO⁻ and phosphoraniminato groups, where R is selected from the group consisting of alkyl, alkenyl, cycloalkyl and aryl groups,
N is nitrogen and
R¹ and R² are identical or different and are selected independently from the group consisting of alkyl, aryl, heteroaryl, alkenyl groups and silicon-containing hydrocarbon radicals.

6. Compounds according to either claim 1 or 5 in which L¹ is a (NR¹R²)⁻ group.

7. A process for preparing the compounds of the formula (I), in which [V(NMe₂)₄] is reacted with one or more compounds containing the ligands Q, L¹ and L².

8. Use of the compounds according to any of claims 1 to 6 for preparing a catalyst composition.

9. Catalyst composition comprising
a) one or more compounds according to any of claims 1 to 6 and
b) one or more cocatalysts.

10. Catalyst composition according to claim 9 in which the cocatalyst or cocatalysts is/are selected from the group consisting of organometallic compounds of groups 1, 2, 12 and 13 of the Periodic Table of the Elements, IUPAC 1985 version.

11. Catalyst composition according to either claim 9 or 10 in which aluminium compounds selected from the group consisting of ethylaluminium chloride, ethylaluminium sequichloride, diethylaluminium chloride and mixtures of these compounds are used as cocatalyst.

12. Catalyst composition according to any of claims 9 to 11 which can additionally contain a promoter.

13. Catalyst composition according to any of claims 9 to 12 in which the promoter is selected from the group consisting of ethyl trichloroacetate, ethyl dichlorophenylacetate, ethyl phenyldichloroacetate and ethyl diphenylchloroacetate.

14. Process for preparing the catalyst composition, which comprises the steps
α) provision of the component a) and component b),
β) mixing of the component a) and component b) in an organic solvent.

15. Process for preparing homopolymers or copolymers of one or more olefins in the presence of a catalyst composition according to any of claims 9 to 13.

16. Process according to claim 15, wherein the polymerization is carried out in solution.

17. Process according to either claim 15 or 16, wherein the temperature during the polymerization is in the range from −100 to +150° C.

18. Process according to any of claims 15 to 17, wherein the olefins are selected from the group consisting of α-olefins and cycloolefins.

19. Process according to any of claims 15 to 18, wherein one monomer for the copolymerization is always ethylene.

20. Process for preparing an ethylene-propylene-diene polymer according to any of claims 15 to 19, wherein the diene is selected from the group consisting of ethylidenenorbornene, dicyclopentadiene, vinylnorbornene and mixtures of these dienes.
